(19) United States
(12) Patent Application Publication
(10) Pub. No.: US 2011/0241937 A1
(43) Pub. Date: Oct. 6, 2011

(54) APPARATUS AND METHOD FOR SIGNAL ACQUISITION IN GLOBAL NAVIGATION SATELLITE SYSTEM RECEIVER

(75) Inventors: Seung Hyun CHOI, Daejeon (KR); Jae Hyun Kim, Daejeon (KR); In One Joo, Daejeon (KR); Cheon Sig Sin, Daejeon (KR); Sang Uk Lee, Daejeon (KR)

(73) Assignee: ELECTRONICS AND TELECOMMUNICATIONS RESEARCH INSTITUTE, Daejeon (KR)

(21) Appl. No.: 13/077,278

(22) Filed: Mar. 31, 2011

(30) Foreign Application Priority Data
Apr. 2, 2010 (KR) 10-2010-0030359
Oct. 19, 2010 (KR) 10-2010-0101913

(51) Int. Cl. G01S 19/30

(52) U.S. Cl. 342/357.69

(57) ABSTRACT

An apparatus for signal acquisition of a Global Navigation Satellite System (GNSS) receiver may downsample digitalized satellite signals based on a code resolution, correlate the downsampled satellite signals and oversampled pseudo-random noise (PRN) codes using a block unit based on a size of a matching filter, and may perform FFT of a value output as a correlation result by employing, as M points, a number of blocks used for the matching filter. Also, the signal acquisition apparatus may estimate a coarse Doppler and a code phase of the satellite signals by comparing a power value, calculated based on the M-point fast Fourier transformed value, with a threshold value, and may estimate a fine Doppler using zero-padding based FFT when the satellite signals are successfully acquired.

### CROSS-REFERENCE TO RELATED APPLICATIONS

This application claims the benefit of Korean Patent Application No. 10-2010-0030359, filed on Apr. 2, 2010, and Korean Patent Application No. 10-2010-0101913, filed on Oct. 19, 2010, in the Korean Intellectual Property Office, the disclosures of which are incorporated herein by reference.

### BACKGROUND

1. Field of the Invention

The present invention relates to a Global Navigation Satellite System (GNSS) receiver, and more particularly, to an apparatus and method associated with a signal acquisition function among functions of the GNSS receiver.

2. Description of the Related Art

A Global Navigation Satellite System (GNSS) receiver may include a signal acquisition function, a signal tracking function, a data decoding function, and a navigation function. The GNSS receiver may receive a satellite signal via an antenna, down convert the satellite signal from a radio frequency (RF) band to an intermediate frequency (IF) band. A digital IF signal corresponds to an input signal of a signal acquisition unit. The signal acquisition unit may search for a satellite using the digital IF signal, and may estimate a code phase and a Doppler frequency of the found satellite. The signal acquisition unit may search a two-dimensional (2D) space using an available combination of the code phase and the Doppler frequency. The signal acquisition unit may sequentially search a search section, and may determine whether a signal is acquired through a correlation test with respect to the corresponding Doppler frequency and the code phase.

### SUMMARY

An aspect of the present invention provides an apparatus and method for signal acquisition of a Global Navigation Satellite System (GNSS) receiver that may downsample high sampling data for receiving a relatively wide bandwidth, and may calculate a correlation value of a matching filter, and thereby may reduce an amount of calculations and a memory.

An aspect of the present invention also provides an apparatus and method for signal acquisition of a GNSS receiver that may be configured as hardware by designing a number of points of a zero-padding based fast Fourier transform (FFT) unit using 2^{N}.

An aspect of the present invention also provides an apparatus and method for signal acquisition of a GNSS receiver that may estimate a Doppler frequency within an error range of tens or a few Hz by adding a number of zero-padding points to an FFT unit.

According to an aspect of the present invention, there is provided an apparatus for signal acquisition of a GNSS receiver, the apparatus including: a downsampling unit to downsample digitalized satellite signals based on a code resolution; a signal and code correlation unit to correlate the downsampled satellite signals and oversampled pseudo-random noise (PRN) codes using a block unit based on a size of a matching filter; an M-point fast Fourier transform (FFT) unit to perform FFT of a value output as a correlation result by employing, as M points, a number of blocks used for the matching filter; a code phase and coarse Doppler estimator to estimate a coarse Doppler and a code phase of the satellite signals by comparing a power value, calculated based on the M-point fast Fourier transformed value, with a threshold value; and a fine Doppler estimator to estimate a fine Doppler using zero-padding based FFT when the satellite signals are successfully acquired.

The signal and code correlation unit may include: a signal buffer to store the downsampled satellite signals; a code buffer to store the oversampled PRN codes; and a matching filter correlation unit to form a successive signal block by dividing the downsampled satellite signals based on the size of the matching filter, to form a code block by dividing the oversampled PRN codes based on the size of the matching filter, and to perform a correlation with the code block by employing two of successive signal blocks as a single unit.

The fine Doppler estimator may include: a zero-padding inserter to insert a predetermined number of zero-paddings into blocks used for the matching filter; an N-point FFT unit to determine N points of FFT based on the number of blocks and the inserted zero-paddings, and to perform FFT of a correlation value of a code phase column succeeding in signal acquisition based on the N points; and a maximum value detector to detect a power having a maximum value among power values calculated based on the N-point fast Fourier transformed value, and to estimate a fine Doppler.

The signal acquisition apparatus of the GNSS receiver may further include: a PRN code generator to generate PRN codes of a satellite; and a code oversampling unit to oversample the PRN codes based on the code resolution.

According to another aspect of the present invention, there is provided a method for signal acquisition of a Global Navigation Satellite System (GNSS) receiver, the method including: downsampling digitalized satellite signals based on a code resolution; acquiring oversampled pseudo-random noise (PRN) codes; correlating the downsampled satellite signals and the oversampled PRN codes using a block unit, based on a size of a matching filter; performing fast Fourier transform (FFT) of a value output as a correlation result by employing, as M points, a number of blocks used for the matching filter; estimating a code phase and a coarse Doppler of the satellite signals by comparing a power value, calculated based on the M-point fast Fourier transformed value, with a threshold value; and estimating a fine Doppler using zero-padding based FFT when the satellite signals are successfully acquired.

The estimating of the code phase and the coarse Doppler may include: calculating a power value based on the M-point fast Fourier transformed value; determining whether the satellite signal acquisition is successful by comparing the threshold value with a ratio of a power having a maximum value in noise to a power having a maximum value among power values; and shifting left an input data block used for the matching filter when the ratio is less than or equal to the threshold value.

The correlating may include: forming a successive signal block by dividing the downsampled satellite signals based on the size of the matching filter; forming a code block by dividing the oversampled PRN codes based on the size of the matching filter; and performing a correlation with the code block by employing two of successive signal blocks as a single unit.

According to embodiments of the present invention, it is possible to reduce an amount of calculations and a memory by downsampling high sampling data for receiving a relative wide bandwidth and by calculating a correlation value of a matching filter.

Also, according to embodiments of the present invention, it is possible to reuse a memory by correlating a satellite signal and a PRN code based on a block unit, and by determining whether a signal is acquired based on the block unit.

Also, according to embodiments of the present invention, a hardware configuration may be enabled by designing a number of points of a zero-padding FFT unit using 2^{N}.

Also, according to embodiments of the present invention, it is possible to estimate a Doppler frequency within an error range of tens or a few of Hz by adding a number of zero-padding points of an FFT unit.

Also, according to embodiments of the present invention, it is possible to determine a resolution of a Doppler frequency based on a size of a zero-padding added FFT unit regardless of a length of input data. Accordingly, an estimation of a fine Doppler frequency is enabled.

Also, according to embodiments of the present invention, it is possible to increase a signal-to-noise (SNR) ratio of a satellite signal by adding a number of zero-padding points of an FFT unit.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating a signal acquisition apparatus of a Global Navigation Satellite System (GNSS) receiver according to an embodiment of the present invention;

FIG. 2 is a block diagram illustrating a configuration of a fine Doppler estimator according to an embodiment of the present invention;

FIG. 3 is a diagram illustrating an operation of a signal and code correlation unit of FIG. 1 using a matching filter according to an embodiment of the present invention;

FIG. 4 is a diagram illustrating a correlation result of a matching filter correlation unit according to an embodiment of the present invention;

FIG. 5 is a graph illustrating a detection probability based on a signal-to-noise ratio (SNR);

FIG. 6 is a graph illustrating a Doppler error based on an SNR;

FIG. 7 is a graph illustrating an estimated SNR based on a number of zero-padded FFT points; and

FIG. 8 is a flowchart illustrating a signal acquisition method of a GNSS receiver according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Currently, a navigation receiver may use a signal acquisition block of a fast Fourier transform (FFT) scheme to satisfy a time to first fix (TTFF). Here, the TTFF indicates an amount of time used to receive an input signal, and to process the input signal, and then to calculate a position of a satellite. A signal acquisition unit may significantly affect a performance of the TTFF and thus, may need to be accelerated by decreasing an amount of calculations. However, in a current navigation system, since a signal has a frequency with a relatively wide bandwidth, a sampling frequency may increase and thereby, an amount of calculations may also increase. In addition, in the case of a hardware design, a number of FFT points may need to be designed based on 2^{N} in order to configure an FFT block.

The signal acquisition unit may need to estimate a fine Doppler for a stable operation of a signal tracking unit. An existing scheme has increased a coherent accumulation time by increasing a length of input data in order to estimate the fine Doppler. For example, when the length of input data is 1 ms, a frequency resolution may be 1 KHz (1/1 ms) that is an inverse number of the length of input data. Accordingly, 10 ms ( 1/100) of coherent accumulation may be used to have a high resolution of 100 Hz. When processing a high sampling input signal, the coherent accumulation scheme based on the length of input data may increase a memory storing the processed data and may also increase an amount of calculations.

According to an embodiment of the present invention, proposed is an algorithm employing a matching filter and a zero-padding FFT scheme to decrease an amount of calculations and a memory, and to estimate a fine Doppler. A signal acquisition apparatus of a Global Navigation Satellite System (GNSS) receiver according to an embodiment of the present invention may reduce an amount of calculations for signal processing and a memory by downsampling a high sampling frequency. An algorithm employing a zero-padding FFT scheme may estimate a high fine Doppler by designing a number of FFT points based on a multiplier of ‘2’ to be configurable in a Xilinx core, and by increasing a number of zero-padding points.

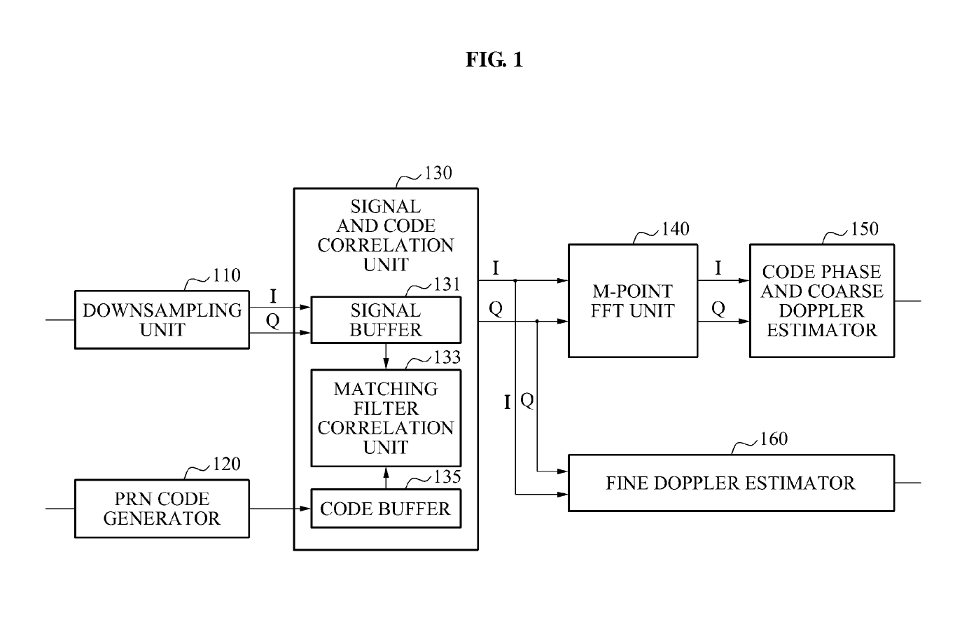

FIG. 1 is a block diagram illustrating a signal acquisition apparatus of a GNSS receiver according to an embodiment of the present invention.

Referring to FIG. 1, the signal acquisition apparatus of the GNSS receiver may include a downsampling unit 110, a pseudo-random noise (PRN) code generator 120, a signal and code correlation unit 130, and an M-point FFT unit 140, a code phase and coarse Doppler estimator 150, and a fine Doppler estimator 160.

A general GNSS receiver may receive a satellite signal via an antenna, convert the received satellite signal to an intermediate frequency (IF) signal, and convert an analog IF signal to a digital IF signal. In the general GNSS receiver, a signal acquisition apparatus may detect the received satellite signal through two-dimensional (2D) search of a code delay and a Doppler frequency.

A signal acquisition algorithm of the GNSS receiver according to an embodiment of the present invention may be designed based on a Doppler search section, a code resolution, a block size of a matching filter, a size of an M-point FFT, a size of an N-point FFT, a Doppler resolution, and the like. The Doppler search section may include a section for searching for the Doppler frequency in order to estimate a position of a satellite. The code resolution indicates a code chip unit for searching. The Doppler resolution indicates a Doppler Hz unit for searching.

A digital IF signal r(tₛ) input into the GNSS receiver may be modeled to Equation 1.

$$r ( {t}_{s} ) = {\sum }_{i = 1}^{{N}_{sat}} \{ A \cdot {d}_{i} ( {t}_{s} - τ ) \cdot {c}_{i} ( {t}_{s} - τ ) cos [ 2 π ( {f}_{IF} - {f}_{Di} ) {t}_{s} - {φ}_{i} ( {t}_{s} ) ] + n ( k ) \} \qquad [ Equation 1 ]$$

In Equation 1, N_{Sat} denotes a number of satellites using a visible light, i denotes a channel number of a corresponding satellite, A denotes a signal amplitude, dᵢ(tₛ−τ) denotes navigation data, cᵢ(tₛ−τ) denotes a code, τ denotes a code phase, f_{IF} denotes an intermediate frequency (IF), f_{Di} denotes the Doppler frequency, φᵢ(tₛ) denotes an initial subcarrier phase, n(k) denotes signal noise, and tₛ denotes a sampling type. A sampling frequency of the digital IF signal may be defined as fₛ, and the code frequency may be defined as f_{c}.

The signal acquisition apparatus of the GNSS receiver may include a subcarrier removal unit (not shown). The subcarrier removal unit may convert the satellite signals to a baseband by multiplying the digitalizing satellite signals by a subcarrier. The satellite signals r_{BB}(tₛ) converted to the baseband may be expressed by r_{BB}(tₛ)=r(tₛ)e^{-j2πf}^{_{IF}}^{·t}^{ₛ}.

The downsampling unit 110 may downsample the digitalized satellite signals based on a code resolution. When the code resolution is assumed as an R chip, the downsampling frequency f_{DS} may correspond to a value obtained by dividing the code frequency by the code resolution. Specifically, the downsampling frequency may be expressed by f_{DS}=f_{c}/R. The downsampling unit 110 may downsample satellite signals with a sampling frequency of fₛ to f_{DS}. Downsampled data r_{DS}(t_{d}) may be expressed by

$${r}_{DS} ( {t}_{d} ) = {\sum }_{{t}_{s} = i}^{i + N} {r}_{BB } ( {t}_{s} ) .$$

Here, N≡fₛ/f_{DS} and the downsampled data may include a summation of satellite signals converted to a number of basebands corresponding to downsampling. t_{d} denotes a sampling type of downsampling and has a period of 1/f_{DS}. The downsampled data r_{DS}(t_{d}) may have code phase information associated with I and Q channels.

A current navigation system may receive a high sampling signal in order to receive a frequency with a relatively wide bandwidth. The downsampling unit 110 may reduce an amount of calculations and a memory by downsampling high sampling satellite signals and by decreasing data used for a calculation process.

The PRN code generator 120 may generate PRN codes of satellites. The PRN code generator 120 may generate the PRN codes to identify corresponding satellites.

The signal acquisition apparatus of the GNSS receiver may include a code oversampling unit (not shown). The code oversampling unit may oversample the PRN codes based on a code resolution. When the code resolution is assumed as an R chip, the oversampling frequency fₒ corresponds to a value obtained by dividing the code frequency by the code resolution. That is, the oversampling frequency may be expressed by fₒ=f_{c}/R.

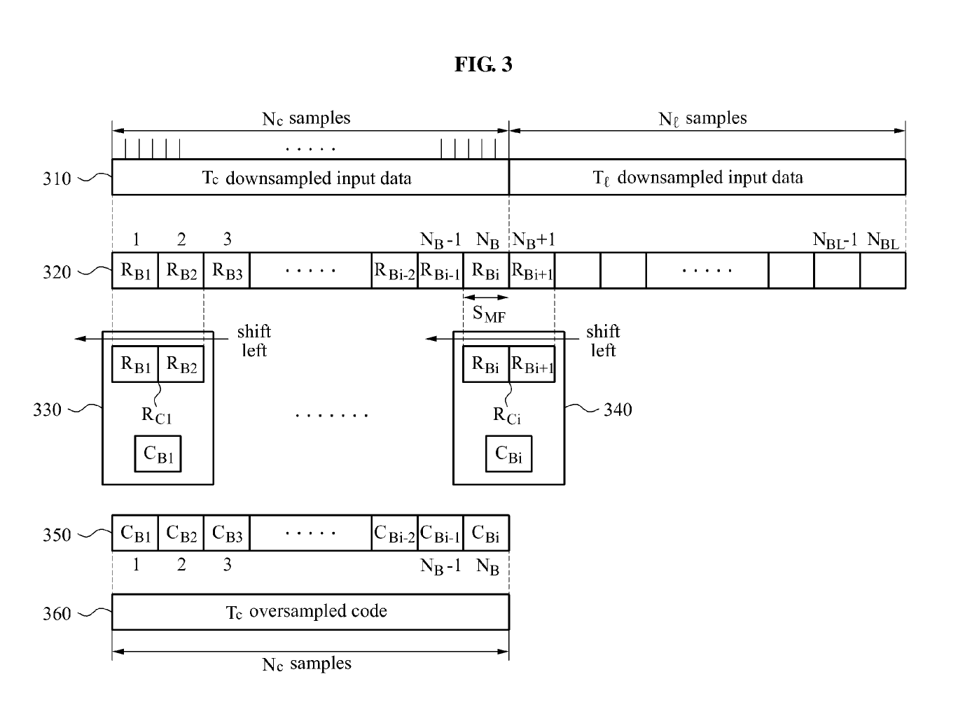

The signal and code correlation unit 130 may correlate the downsampled satellite signals and the oversampled PRN codes using a block unit, based on a size of a matching filter. The signal and code correlation unit 130 may include a signal buffer 131, a code buffer 135, and a matching filter correlation unit 133. The signal buffer 131 may store the downsampled satellite signals. The code buffer 135 may store the oversampled PRN codes. The matching filter correlation unit 133 may form a successive signal block by dividing the downsampled satellite signals based on the size of the matching filter, may form a code block by dividing the oversampled PRN codes based on the size of the matching filter, and may perform a correlation with the code block by employing two of successive signal blocks as a single unit. That is, the matching filter correlation unit 133 may correlate the two successive signals blocks and the code block. The matching filter may be used for only a portion of downsampled data. An operation of the matching filter correlation unit 133 will be further described with reference to FIG. 3.

The signal acquisition apparatus of the GNSS receiver may include a coherent memory (not shown). The coherent memory may coherently accumulate a value output from the matching filter correlation unit 133.

The M-point FFT unit 140 may perform FFT of a value output as a correlation result by employing, as M points, a number of blocks used for the matching filter. The number of blocks used for the matching filter may be determined by dividing a sample used for the matching filter by the size of the matching filter.

The signal acquisition apparatus of the GNSS receiver may include a non-coherent memory (not shown). The non-coherent memory may non-coherently accumulate a power value based on an M-point fast Fourier transformed value.

The code phase and coarse Doppler estimator 150 may estimate a coarse Doppler and a code phase of the satellite signals by comparing a power value, calculated based on the M point fast Fourier transformed value, with a threshold value. Here, when a power having a maximum value among power values accumulated in the non-coherent memory is Pₛ, and a power having a maximum value in noise is Pₙ, a corresponding ratio P_{Ratio} may be defined as Pₛ/Pₙ. More specifically, when the ratio P_{Ratio} is greater than a threshold value η, the code phase and coarse Doppler estimator 150 may determine that a satellite signal acquisition is successful. The success of the satellite signal acquisition indicates that it is possible to estimate position information of a satellite using a code phase and a Doppler corresponding to a case where the ratio is greater than the threshold. The power calculated based on the M-point fast Fourier transformed value may be indicated as P_{i,j}. The power of when the satellite signal acquisition is successful may be indicated as P_{c,d}. Here, c denotes an index of a code phase and d denotes an index of coarse Doppler. The code phase and coarse Doppler estimator 150 may transmit the estimated code phase to a signal tracking unit.

When the ratio P_{Ratio} is less than or equal to the threshold η, the code phase and coarse Doppler estimator 150 may determine that the satellite signal acquisition is a failure, and may shift left an input data block in order to change a code phase to be estimated. The code phase and coarser Doppler estimator 150 may repeat the shift by M points and calculate the power corresponding to a case where the ratio P_{Ratio} is greater than the threshold η. Accordingly, when all of power values corresponding to the M points are less than or equal to the threshold η, a signal acquisition may be determined as a failure with respect to a satellite corresponding to a current PRN code, and a signal acquisition may be performed with respect to a satellite corresponding to a subsequent PRN code.

The resolution of the coarse Doppler may be determined based on a Doppler search range and M points. The Doppler search range may be determined by dividing the downsampling frequency f_{DS} by the size of the matching filter. The resolution of the coarse Doppler may be determined by dividing the Doppler search range by the M points.

When the satellite signals are successfully acquired, the fine Doppler estimator 160 may perform a fine Doppler using zero-padding based FFT. The fine Doppler estimator 160 may add a zero-padding to a correlation value of when the satellite signal acquisition is successful, and perform N-point FFT. N points may be determined by adding a number of zero-paddings to the M points. The fine Doppler estimator 160 may calculate a power value based on an N-point fast Fourier transformed value, and may estimate, as an index of the fine Doppler, an index of a power having a maximum value. The fine Doppler estimator 160 may transmit, to the signal tracking unit, the fine Doppler corresponding to the index of the power having the maximum value.

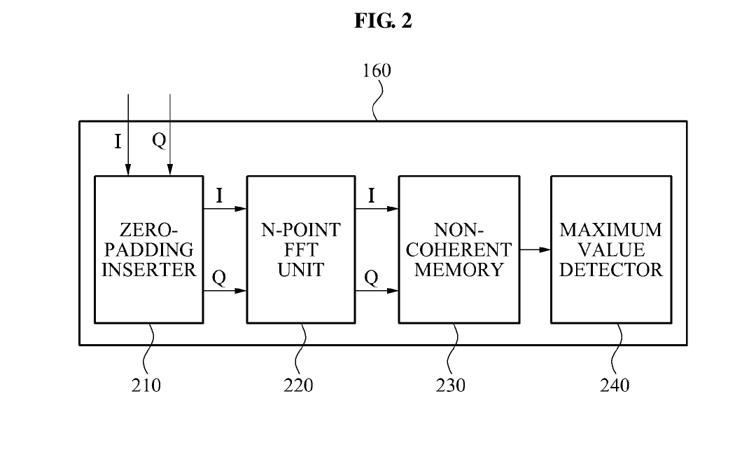

FIG. 2 is a block diagram illustrating a configuration of the fine Doppler estimator 160 according to an embodiment of the present invention.

Referring to FIG. 2, the fine Doppler estimator 160 may include a zero-padding inserter 210, an N-point FFT unit 220, a non-coherent memory 230, and a maximum value detector 240.

The zero-padding inserter 210 may insert a predetermined number of zero-paddings into blocks used for a matching filter. When a satellite signal acquisition is determined as a success by the code phase and coarse Doppler estimator 150, the zero-padding inserter 210 may insert the predetermined number of zero-paddings with respect to a code phase column corresponding to the above success case. A number of zero-paddings may be determined based on a resolution of a fine Doppler. The resolution of the fine Doppler may be determined based on a Doppler search range and N points. The Doppler search range may be determined by dividing the downsampling frequency f_{DS} by a size of a matching filter. The N point may be determined by adding up the number of zero-paddings to the M point. Accordingly, as the number of zero-paddings increases, the resolution of the fine Doppler may also increase.

The N-point FFT unit 220 may determine N points of FFT based on the number of blocks used for the matching filter and the inserted zero-paddings, and may perform FFT of a correlation value of the code phase column succeeding in a signal acquisition. The number of blocks used for the matching filter may be determined by dividing a sample used for the matching filter by the size of the matching filter, and may have the same value as the M points. The N points may be determined by adding up the number of zero-paddings to the M points. The N-point FFT unit 220 may perform FFT by inserting a number of zero-paddings corresponding to the N points into the correlation value of the code phase column corresponding to a case where the satellite signal acquisition is successful.

The non-coherent memory 230 may non-coherently accumulate a power value based on an N-point fast Fourier transformed value.

The maximum value detector 240 may estimate a fine Doppler by detecting a power having a maximum value among power values calculated based on the N-point fast Fourier transformed value. The maxim value detector 20 may estimate, as an index of the fine Doppler, an index of the power having the maximum value among values calculated with respect to each output value of the N-point FFT unit.

FIG. 3 is a diagram illustrating an operation of the signal and code correlation unit 130 using a matching filter according to an embodiment of the present invention.

Referring to FIG. 3, the signal and code correlation unit 130 may include signal buffers 310 and 320, a matching filter correlation unit 330, and code buffers 350 and 360.

Downsampled data r_{DS}(t_{d}) may be stored in the signal buffers 310 and 320, and may have a length of T_{Data}. The downsampled data r_{DS}(t_{d}) may be input into the matching filter correlation unit 330. A number N_{DS} of samples of the downsampled data r_{DS}(t_{d}) may be expressed by N_{DS}=T_{Data}·f_{DS}. When the size of the matching filter is defined as S_{MF}, the Doppler search range f_{search} may be expressed by f_{search}=f_{DS}/S_{MF} To correlate the downsampled data r_{DS}(t_{d}) for each block unit divided based on the size of the matching filter, when the number N_{DS} of samples is divided by the size S_{MF} of the matching filter, a total number N_{BL} of blocks of the downsampled data r_{DS}(t_{d}) may be expressed by N_{BL}=N_{DS}/S_{MF}. N_{B} blocks having the length S_{MF} of the matching filter is defined as R_{Bi}(t_{d}), (i=1, 2, . . . , N_{BL}). Here, a length of input samples to be used for the matching filter is T_{c}, and N_{c} samples are used. Accordingly, the number N_{B} of blocks of the input samples used for the matching filter may be expressed by N_{B}=N_{c}/S_{MF}.

Among the downsampled data r_{DS}(t_{d}), a number N_{L} of blocks of input samples unused for the matching filter or to be used for a subsequent matching filter may be expressed by N_{L}=Nₗ/S_{MF}. Here, a length of the input samples is Tₗ, and Nₗ samples are used. Accordingly, a total number N_{BL} of blocks of the downsampled data r_{DS}(t_{d}) may be expressed by N_{BL}=N_{B}+N_{L}.

The M points of the M-point FFT unit 140 is the same as the number of blocks used for the matching filter and thus, the M point M_{FFT} may be expressed by M_{FFT}=N_{B}.

An oversampled PRN code may be stored in the code buffers 350 and 360. An input code may be assumed as C(t_{c}). t_{c}=1/f_{c}. When oversampling is performed based on an R chip that is a code resolution, an oversampling frequency fₒ may be expressed by fₒ=f_{c}/R. A code used for the matching filter may have a length of T_{c} sec to obtain a coherent gain of T_{c} sec and downsampled input data. When the oversampled code is defined as Cₒ(tₒ), tₒ may be 1/fₒ and be the same as a sampling time t_{d} of downsampling. A number of oversamples is Nₒ=T_{c}·fₒ. For example, when R=0.5 chip in a GPS L1 signal, a total number of codes is 1023 and thus, the oversampling code may be expressed as follows:

$${C}_{o} ( 1 ) = {C}_{o} ( 2 ) = C ( 1 )$$

$${C}_{o} ( 3 ) = {C}_{o} ( 4 ) = C ( 2 ) \\ \begin{matrix}… \\ {C}_{o} ( 2045 ) = {C}_{o} ( 2046 ) = C ( 1023 )\end{matrix}$$

Here, Cₒ(tₒ) is divided by N_{B} blocks to be the same as a number of blocks of downsampled input samples used for the matching filter. The N_{B} blocks having the length S_{MF} of the matching filter is defined as C_{Bi}(t₀), (i=1, 2, . . . , N_{B}) That is, T_{c} sec oversampled code may be divided into the N_{B} blocks.

The matching filter correlation units 330 and 340 may correlate the downsampled input data with the code oversampled based on a block unit, using the matching filter. The downsampled data R_{DS}(t_{d}) of T_{Data} sec may be divided into N_{BL} blocks and the T_{c} sec oversampled code may be divided into N_{B} blocks. Each input block of the downsampled data R_{DS}(t_{d}) may be defined as R_{Ci}(t_{d}), (i=1, 2, . . . , N_{BL}) by configuring two successive blocks as a single block unit. A correlation result of an i^{th} block R_{Ci}(t_{d}) of the downsampled data R_{DS}(t_{d}) and an i^{th} block C_{Bi}(tₒ) of the oversampled code may be expressed by Equation 2.

$${S}_{i , j} = {\sum }_{t = 1}^{{S}_{MF}} {R}_{α} ( t + j - 1 ) \cdot {C}_{Bi} ( t ) , \\ ( i = 1 , 2 , … , {N}_{B} ) , \\ ( j = 1 , 2 , … , {S}_{MF} ) , \\ ( {S}_{i , j} complex number ) \qquad [ Equation 2 ]$$

Hereinafter, referring to Equation 2, an operation of the M-point FFT unit 140, the code phase and coarse Doppler estimator 150, and the fine Doppler estimator 160 will be described.

When FFT is performed with respect to all i^{th} rows in a fixed j^{th} column, a result of the FFT may be expressed by Equation 3.

$$[ {S}_{1 , 1} , {S}_{2 , 1} , … , {S}_{{N}_{B} , 1} ] = FFT [ {S}_{1 , 1} , {S}_{2 , 1} , … , {S}_{{N}_{B} , 1} ] \\ \begin{matrix}… \\ [ {S}_{1 , {S}_{MF}} , {S}_{2 , {S}_{MF}} , … , {S}_{{N}_{B} , {S}_{MF}} ] = FFT [ {S}_{1 , {S}_{MF}} , {S}_{2 , {S}_{MF}} , … , {S}_{{N}_{B} , {S}_{MF}} ]\end{matrix} \qquad [ Equation 3 ]$$

Specifically, when FFT is performed for an output S_{i,j} of the matching filter correlation units 330 and 340, the M-point FFT unit 140 may calculate S_{i,j}. Here, S_{i,j} denotes a complex number. A power of fast Fourier transformed S_{i,j} may be calculated according to Equation 4.

[P_{1,j},P_{2,j}, . . . ,P_{N}_{_{B}}_{,j}]=[|S_{1,j}|²,|S_{2,j}|², . . . ,|S_{N}_{_{B}}_{,j}|²], (j=1,2, . . . ,S_{MF}) [Equation 4]

That is, P_{i,j}=|S_{i,j}|². When a power having a maximum value among calculated power values is Pₛ, and a power having a maximum value in noise is Pₙ, a corresponding ratio P_{Ratio} may be defined as Pₛ/Pₙ. When the ratio P_{Ratio} is greater than a predetermined threshold value η, the code phase and coarse Doppler estimator 150 may determine a satellite signal acquisition is successful. The success of the satellite signal acquisition indicates that it is possible to estimate position information of a satellite based on a code phase and Doppler corresponding to a case where the ratio P_{Ratio} is greater than the threshold η. The power of when the satellite signal acquisition is successful may be expressed by P_{c,d}. c denotes an index of the code phase and d denotes an index of the coarse Doppler. When the ratio P_{Ratio} is less than or equal to the threshold η, the code phase and coarse Doppler estimator 150 may determine the satellite signal acquisition is a failure, and may shift left an input data block in order to change a code phase to be estimated. That is, R_{B2}(t) becomes R_{B1}(t) and R_{Bi+1}(t) becomes R_{Bi}(t) whereby a matching filter correlation, an M-point FFT, and a power value calculation of a FFT result may be repeatedly performed.

When a satellite signal acquisition is successful in a j^{th} code phase column of a correlation value s_{i,j}, the fine Doppler estimator 160 may insert a zero-padding as shown in Equation 5, and may perform N-point FFT. The N points may be determined by adding up a number of zero-paddings to the M points.

[S_{1,j},S_{2,j}, . . . ,S_{N}_{_{FFT}}_{,j}]=FFT[s_{1,j},s_{2,j}, . . . ,s_{i,j},0_{i+1,j}, . . . ,0_{N}_{_{FFT}}_{,j}] [Equation 5]

A power of fast Fourier transformed S_{i,j} may be calculated using P_{i,j}=|S_{i,j}|². P_{c,d}=Pₛ=MAX[P_{1,j}, P_{2,j}, . . . , P_{N}_{_{FFT}}_{,j}] Here, when an i^{th} row has a maximum value, the fine Doppler estimator 160 may estimate the i^{th} row as an index of the fine Doppler.

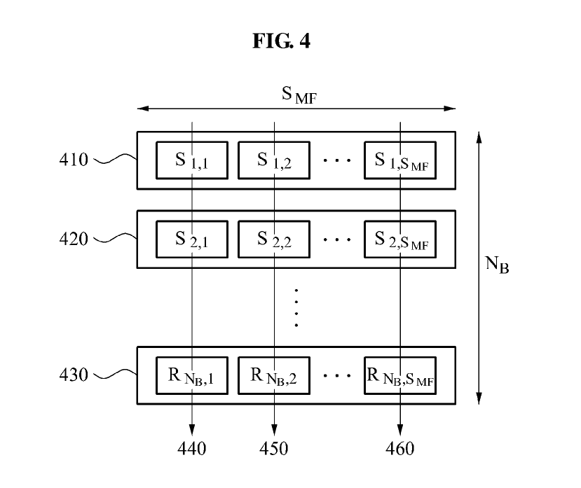

FIG. 4 is a diagram illustrating correlation results 410 and 430 of the matching filter correlation units 330 and 340 according to an embodiment of the present invention.

FIG. 4 shows the correlation result 410 of the matching filter correlation unit 330 and the correlation result 430 of the matching filter correlation unit 340. That is, FIG. 4 shows correlation results 410, 420, and 430 of an i^{th} block R_{Ci}(t_{d}) of downsampled data R_{DS}(t_{d}) and an i^{th} block of an oversampled code C_{Bi}(tₒ).

The M-point FFT unit 140 may perform FFT with respect to all the i^{th} rows in a fixed j^{th} column. In FIG. 4, a first M-point FFT 440 may be performed with respect to all of N_{B} rows in a first column. A second M-point FFT 450 may be performed with respect to all of N_{B} rows in a second column, and a final M-point FFT 460 may be performed with respect to all of N_{B} rows in a last column.

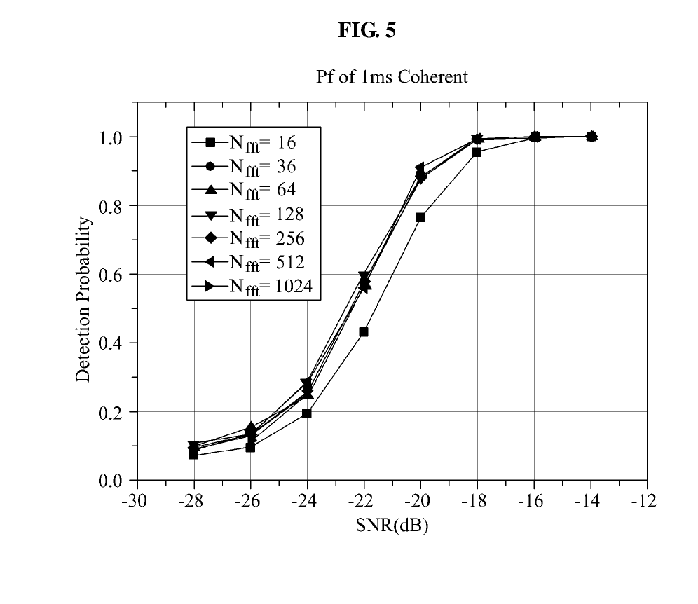

FIG. 5 is a graph illustrating a detection probability based on an SNR.

An existing signal acquisition scheme does not use a downsampling. Accordingly, when a high sampling is used, an amount of calculations and a memory for signal processing may increase. However, a signal acquisition apparatus of a GNSS receiver according to an embodiment of the present invention may process data as low sampling using a downsampling scheme and thus, it is possible to decrease a memory and an amount of calculations for data processing. For example, when an input signal has a sampling of 112 MHz, and when the input signal is downsampled to 2.046 MHz, a memory for the input data may be reduced to 2.46/112=1/54.7, and an amount of calculations may also decrease to be in proportion to the memory of the input data.

In the case of an existing scheme, a frequency resolution of a signal acquisition unit may be determined based on a length sec of an input signal. For example, when a signal acquisition algorithm is applied to 10 ms that is a length of input data, a frequency resolution may have a unit of 100 Hz ( 1/10 ms) that is an inverse number of the data length. Accordingly, in the case of the existing scheme that determines the frequency resolution based on the length of input data, when increasing the Doppler resolution, the data length may increase whereby a memory storing the input data may increase and a processing amount may also increase. The signal acquisition apparatus of the GNSS receiver according to an embodiment of the present invention may determine the frequency resolution regardless of the length of input data. For example, the signal acquisition apparatus may estimate the fine Doppler based on an N-point size that is determined based on a number of zero-paddings.

FIG. 5 shows a simulation result of a detection probability based on an SNR by applying a plurality of values to the signal acquisition apparatus of the GNSS receiver according to an embodiment of the present invention. In this instance, it is assumed that the input signal is a GPS L1 signal, the code resolution is 0.5 chip, a downsampling frequency is 2.046 MHz, and a Doppler search range is −8 KHz to 8 KHz. A case where the size S_{MF} of the matching filter is 128, a number of non-coherent accumulations is a one time, and 1 ms is a coherent accumulation may be used.

All the simulation values denote a value that is an average value obtained through 1000 simulations. To obtain a detection probability, the signal acquisition apparatus may induce a maximum value from a final power value without using a threshold value, and may verify whether a Doppler and a code are accurate. FIG. 5 illustrates a detection probability of a satellite signal based on an input SNR when applying the coherent accumulation of 1 ms. In the case of at least two folds of N-point size N_{FFT} by inserting a predetermined number of zero-paddings in the basic N-point size N_{FFT}, the detection probability may nearly have the same value.

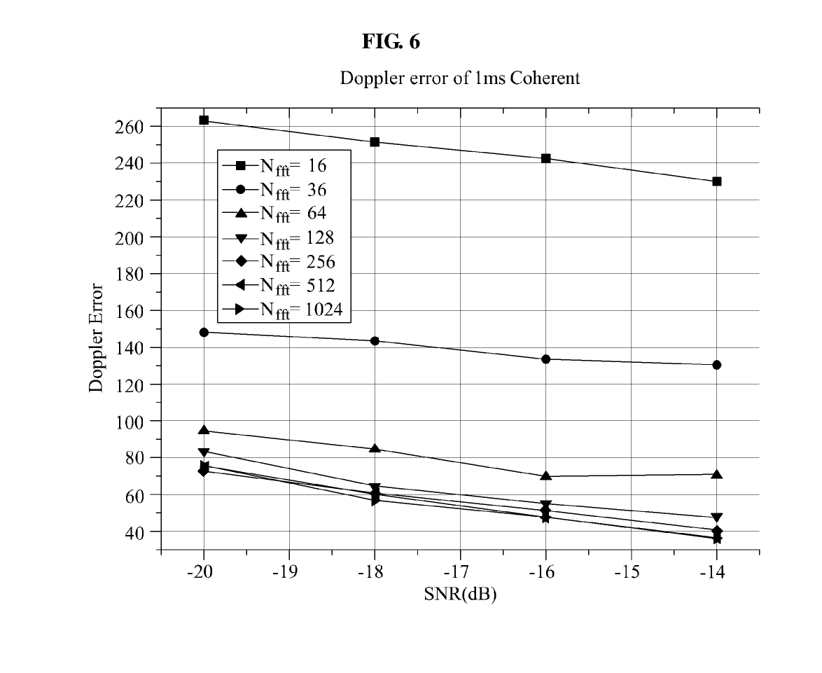

FIG. 6 is a graph illustrating a Doppler error based on an SNR.

FIG. 6 shows a simulation result with respect to a Doppler error based on a zero-padded N-point size N_{FFT} when the satellite signal detection probability is greater than or equal to 70% by applying a plurality of values to a signal acquisition apparatus of a GNSS receiver according to an embodiment of the present invention. Here, it is assumed that an input signal is a GPS L1 signal, a code resolution is a 0.5 chip, a downsampling frequency is 2.046 MHz, and a Doppler search range is −8 KHz to 8 KHz. A case where the size S_{MF} of the matching filter is 128, a number of non-coherent accumulations is a one time, and 1 ms and 2 ms are a coherent accumulation may be used. Based on the assumption that a bit inversion effect does not exist, the Doppler error indicates a difference between a Doppler value input when generating a satellite signal and a Doppler estimated at the signal acquisition unit.

In a case where the SNR is −14 dB, when the signal acquisition apparatus uses 16 points, the Doppler error may have the average error of 250 Hz. When the signal acquisition apparatus uses 1024 points, the Doppler error may have the average error of 36 Hz. A scheme of estimating the fine Doppler by inserting a zero-padding may decrease the Doppler error according to an increase in the N-point size N_{FFT}. However, in a predetermined N-point size N_{FFT}, the Doppler error may not further decrease.

Referring to Table 1, in the case of the coherent 1 m as a simulation result, the maximum zero-padded N-point size N_{FFT} minimizing the Doppler error may be 512. In the case of the coherent 2m, the maximum zero-padded N-point size N_{FFT} may be 1024.

TABLE 1

| | 1 ms | | | | | | 2 ms | | | | | |
|---|---|---|---|---|---|---|---|---|---|---|---|---|
| Basic FFT Points | 16 | | | | | | 32 | | | | | |
| Zero-Padded | 16 | | 32 | | 512 | | 32 | | 64 | | 1024 | |
| FFT Points | (0 Zeros) | | (16 zeros) | | (496 zeros) | | (0 zeros) | | (32 zeros) | | (992 zeros) | |
| Doppler Err | 250 | Hz | 130 | Hz | 36 | Hz | 124 | | 62 | Hz | 13 | Hz |
| SNR | 17.2 | dB | 18.0 | dB | 18.4 | dB | 20.22 | dB | 21.09 | dB | 21.42 | dB |

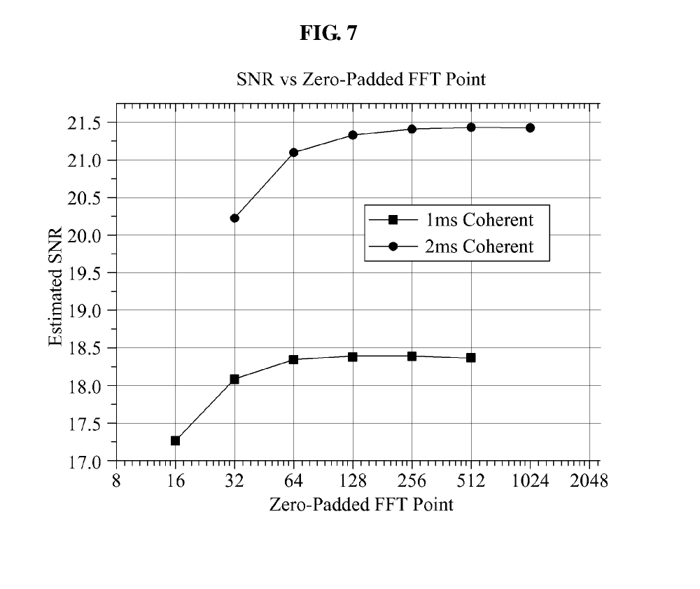

FIG. 7 is a graph illustrating an estimated SNR based on a number of zero-padded FFT points.

FIG. 7 shows an SNR of a signal estimated by the signal acquisition unit based on the N-point size N_{FFT} with respect to each of 1 ms and 2 ms when the SNR is −14 dB. Referring to Table 1, in the case of 1 ms coherent accumulation, the SNR performance may increase by maximum 1.2 dB in 512 points compared to 16 points. In the case of 2 ms, the performance may increase by maximum 1.2 dB in 1024 points compared to 32 points. As the N-point size N_{FFT} increases, the SNR may also increase. However, the SNR may not further increase in the predetermined N-point size N_{FFT}.

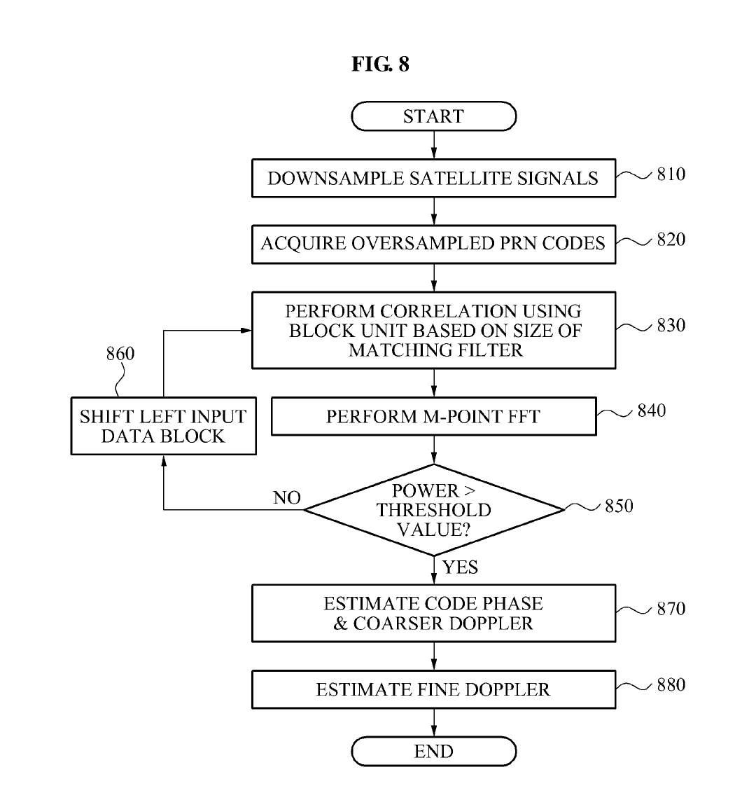

FIG. 8 is a flowchart illustrating a signal acquisition method of a GNSS receiver according to an embodiment of the present invention.

In operation 810, a signal acquisition apparatus of the GNSS receiver may downsample digitalized satellite signals based on a code resolution. The signal acquisition apparatus may generate PRN codes and may oversample the PRN codes based on the code resolution.

In operation 820, the signal acquisition apparatus may acquire the oversampled PRN codes.

In operation 830, the signal acquisition apparatus may correlate the downsampled satellite signals and the oversampled PRN codes using a block unit, based on a size of a matching filter. The signal acquisition apparatus may form a successive signal block by dividing the downsampled satellite signals by the size of the matching filter. The signal acquisition apparatus may perform correlation with the code block by using two of successive signals blocks as a single unit.

In operation 840, the signal acquisition apparatus may perform FFT of a value output as a correlation result by employing, as M points, a number of blocks used for the matching filter.

In operation 850, the signal acquisition apparatus may compare a power value, calculated based on the M-point fast Fourier transformed value, with a threshold value. The signal acquisition apparatus may determine whether the satellite signal acquisition is successful by comparing the threshold value with a ratio of a power having a maximum value in noise to a power having a maximum value among power values. When the ratio is greater than the threshold, the signal acquisition apparatus may determine the satellite signal acquisition is successful.

When the ratio is less than or equal to the threshold, the signal acquisition apparatus may shift left an input data block used for the matching filter in operation 860.

When the power is greater than the threshold, the signal acquisition apparatus may estimate a code phase and a coarse Doppler of the satellite signals in operation 870.

When the satellite signals are successfully acquired, the signal acquisition apparatus may estimate a fine Doppler using zero-padding based FFT. The signal acquisition apparatus may insert a predetermined number of zero-paddings into blocks used for the matching filter. The signal acquisition apparatus may determine N points of the FFT based on the number of blocks and the inserted zero-paddings, and may perform FFT of a correlation value of a code phase column succeeding in the signal acquisition based on the determined N-points. The signal acquisition apparatus may estimate a fine Doppler by calculating a power based on an N-point fast Fourier transformed value, and by detecting a power having a maximum value.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus for signal acquisition of a Global Navigation Satellite System (GNSS) receiver, the apparatus comprising:
a downsampling unit to downsample digitalized satellite signals based on a code resolution;
a signal and code correlation unit to correlate the downsampled satellite signals and oversampled pseudo-random noise (PRN) codes using a block unit based on a size of a matching filter;
an M-point fast Fourier transform (FFT) unit to perform FFT of a value output as a correlation result by employing, as M points, a number of blocks used for the matching filter;
a code phase and coarse Doppler estimator to estimate a coarse Doppler and a code phase of the satellite signals by comparing a power value, calculated based on the M-point fast Fourier transformed value, with a threshold value; and
a fine Doppler estimator to estimate a fine Doppler using zero-padding based FFT when the satellite signals are successfully acquired.

2. The apparatus of claim 1, further comprising:
a subcarrier removal unit to convert the satellite signals to a baseband by multiplying the digitalized satellite signals by a subcarrier.

3. The apparatus of claim 1, further comprising:
a PRN code generator to generate PRN codes of a satellite; and
a code oversampling unit to oversample the PRN codes based on the code resolution.

4. The apparatus of claim 1, wherein the signal and code correlation unit comprises:
a signal buffer to store the downsampled satellite signals;
a code buffer to store the oversampled PRN codes; and
a matching filter correlation unit to form a successive signal block by dividing the downsampled satellite signals based on the size of the matching filter, to form a code block by dividing the oversampled PRN codes based on the size of the matching filter, and to perform a correlation with the code block by employing two of successive signal blocks as a single unit.

5. The apparatus of claim 1, further comprising:
a non-coherent memory to non-coherently accumulate the power value calculated based on the M-point fast Fourier transformed value.

6. The apparatus of claim 1, further comprising:
a coherent memory to coherently accumulate a value output by correlating the downsampled satellite signals and the oversampled PRN codes using the block unit based on the size of the matching filter.

7. The apparatus of claim 1, wherein a resolution of a coarse Doppler is determined based on a Doppler search range and the M points.

8. The apparatus of claim 1, wherein the fine Doppler estimator comprises:
a zero-padding inserter to insert a predetermined number of zero-paddings into blocks used for the matching filter;
an N-point FFT unit to determine N points of FFT based on the number of blocks and the inserted zero-paddings, and to perform FFT of a correlation value of a code phase column succeeding in signal acquisition based on the N points; and
a maximum value detector to detect a power having a maximum value among power values calculated based on the N-point fast Fourier transformed value, and to estimate a fine Doppler.

9. The apparatus of claim 8, further comprising:
a non-coherent memory to non-coherently accumulate a power value calculated based on the N-point fast Fourier transformed value.

10. The apparatus of claim 8, wherein a resolution of the fine Doppler is determined based on a Doppler search range and the N points.

11. A method for signal acquisition of a Global Navigation Satellite System (GNSS) receiver, the method comprising:
downsampling digitalized satellite signals based on a code resolution;
acquiring oversampled pseudo-random noise (PRN) codes
correlating the downsampled satellite signals and the oversampled PRN codes using a block unit, based on a size of a matching filter;
performing fast Fourier transform (FFT) of a value output as a correlation result by employing, as M points, a number of blocks used for the matching filter;
estimating a code phase and a coarse Doppler of the satellite signals by comparing a power value, calculated based on the M-point fast Fourier transformed value, with a threshold value; and
estimating a fine Doppler using zero-padding based FFT when the satellite signals are successfully acquired.

12. The method of claim 11, wherein the estimating of the code phase and the coarse Doppler comprises:
calculating a power value based on the M-point fast Fourier transformed value;
determining whether the satellite signal acquisition is successful by comparing the threshold value with a ratio of a power having a maximum value in noise to a power having a maximum value among power values; and
shifting left an input data block used for the matching filter when the ratio is less than or equal to the threshold value.

13. The method of claim 11, further comprising:
generating PRN codes of a satellite; and
oversampling the PRN codes based on the code resolution.

14. The method of claim 11, wherein the correlating comprises:
forming a successive signal block by dividing the downsampled satellite signals based on the size of the matching filter;
forming a code block by dividing the oversampled PRN codes based on the size of the matching filter; and
performing a correlation with the code block by employing two of successive signal blocks as a single unit.

15. The method of claim 11, wherein the estimating of the fine Doppler comprises:
inserting a predetermined number of zero-paddings into blocks used for the matching filter;
determining N points of an FFT based on the number of blocks and the inserted zero-paddings;
performing FFT of a correlation value of a code phase column succeeding in signal acquisition based on the N points; and
calculating a power value based on the N-point fast Fourier transformed value; and
detecting a power having a maximum value among power values, and estimating a fine Doppler.
